(19) United States
(12) Patent Application Publication
(10) Pub. No.: US 2012/0297332 A1
(43) Pub. Date: Nov. 22, 2012

(54) ADVANCED PREDICTION

(75) Inventors: BYRON H. CHANGUION, Bellevue, WA (US); CHIWEI CHE, Beijing (CN); TAYLOR TAI, Beijing (CN)

(73) Assignee: MICROSOFT CORPORATION, Redmond, WA (US)

(21) Appl. No.: 13/350,204

(22) Filed: Jan. 13, 2012

(30) Foreign Application Priority Data
May 20, 2011 (CN) PCT/CN2011/074405

(51) Int. Cl. G06F 3/048

(52) U.S. Cl. 715/780

(57) ABSTRACT

Described herein is an IME that makes text predictions (e.g., character, phonetic, symbol, word, phrase, and number) and suggests the predictions to a user based on text previously entered in a text box. The IME may base the predictive text on entries in a table or dictionary or historical user text entries. Initial predictions of text are suggested when nothing is entered in the text box. Numeric or punctuation may also be suggested when appropriate. If no predictions can be ascertained, the IME may suggest default predictions to the user.

### CROSS-REFERENCE TO RELATED APPLICATIONS

This application is a continuation of and claims priority to PCT Application No. CN20011/074405, filed on May 20, 2011 and entitled “ADVANCED PREDICTION.”

### BACKGROUND

Input method editors (“IMEs”) predict words from phonetics or text entered by users into text applications. In Chinese, phonetics—such as pinyin or Bopomofo are entered by users to spell out native characters on a QWERTY keypad. In English, letters are entered to spell out words. IMEs take the initial phonetics or letters entered by a user, attempt to predict what character or word the user is trying to type, and then present the prediction to the user for quick selection. If the IME predicts correctly, the user can simply select the predicted characters or word to be entered instead of having to finish spelling the word or character out. Accurate predictions thus save the user time when entering text.

### SUMMARY

This summary is provided to introduce a selection of concepts in a simplified form that are further described below in the Detailed Description. This summary is not intended to identify key features or essential features of the claimed subject matter. Nor is this summary intended to be used as an aid in determining the scope of the claimed subject matter.

One aspect of the invention is directed to a computing device equipped with one or more processors that execute an IME. The IME predicts characters, text, punctuation, or symbols and suggests such predictions to a user. Memory on the computing device, or money accessible across a network, stores instructions associated with the IME. Predictions are eventually displayed to the user on a screen, and the user can select which (if) any predictions to enter, using a keyboard or other input device (e.g., mouse, trackball, scroll pad, touch screen, or the like).

Another aspect is directed to a computing device executing instructions for predicting text entry in a text field and displaying the characters to a user for selection. User-entered text entries are analyzed, and a stored table mapping text entries to predictive text, characters, symbols, or numbers is accessed. Based on the user-entered text and/or the input scope of the text field, a group of predictive text entries in the table is identified. This group of predictive text entries are then displayed to the user for selection.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing device, according to one embodiment;

FIG. 2 is a diagram illustrating a flowchart of an IME, according to one embodiment;

FIG. 3 is a diagram of a computing device displaying predictions of an IME, according to one embodiment;

FIG. 4 is a diagram of a computing device displaying predictions of an IME, according to one embodiment;

FIG. 5 is a diagram of a computing device displaying predictions of an IME, according to one embodiment; and

FIG. 6 is a diagram of a computing device displaying predictions of an IME, according to one embodiment.

### DETAILED DESCRIPTION

The subject matter described herein is presented with specificity to meet statutory requirements. The description herein is not intended, however, to limit the scope of this patent. Instead, the claimed subject matter may also be embodied in other ways, to include different steps or combinations of steps similar to the ones described in this document, in conjunction with other present or future technologies. For illustrative purposes, embodiments are described herein with reference to English words and Chinese characters. Embodiments are not limited to those two languages, however, as the embodiments may be applied to other languages.

In general, embodiments described herein are direct towards improving character or text predictions of IMEs on computing devices and mobile phones. Embodiments perform initial predictions, symbol predictions, numeric predictions, default predictions, and combinations thereof. “Predictions,” as referred to herein, are suggestive text, characters, phrases, phonetics (e.g., pinyin), or numbers determined to be likely candidates for what a user is trying or would like to text. For example, the word “baseball” may be suggested to someone who has just typed “b-a-s-e-b,” or “ [symbol] ” may be suggested after the user enters “ [symbol] ,” predicting that the user is trying to type “ [symbol] ” Predictions are displayed, in one embodiment, to a user for selection, or in another embodiment, are automatically entered into a text field the user has in focus. Examples of different predictive combinations number far too many to describe exhaustively, but it should at least be noted that different embodiments predict and suggest various characters, text, punctuation, and symbols in different circumstances.

In one embodiment, an initial prediction is made when no text is entered in a text field or text box. Initial predictions list common characters, text, or phrases used in the beginning of text, such as “The,” “A or An,” “ [symbol] ” or “Hello,” or other characters, text, or phrases. In one embodiment, initial predictions account for the context of text fields in focus. For example, a text field for a password may invoke the IME to suggest a common password used on a computing device or by the user. Or, in another example, detecting that the text field is a messaging application may trigger the IME to automatically capitalize the first letter of the message or begin it with a salutation (e.g., “Dear,” “To Whom It May Concern,” “Hello,” or the like). Some embodiments determine text box context from associated input scopes, which are discussed in more detail below.

Another embodiment is directed to predicting symbols or punctuation. In this embodiment, predictions of punctuation are based on particles previously entered by a user that mark the ends of sentences, end of paragraphs, sentence tense, or text commonly entered before punctuation. For example, the Chinese characters “ [symbol] ” and “ [symbol] ” may indicate emphasis in a sentence, requiring an exclamation point. Additionally, punctuation may be based on words or characters in a sentence—e.g., beginning a sentence with “How,” “What,” or “ [symbol] ,” indicating a question and thus resulting in a question mark being predicted.

Still another embodiment is directed to predicting common characters, text, or phrases following a number. Such predictions may be based on the number itself. For example, a two digit number may trigger the IME to predict “minutes” should follow, or a ten digit number may trigger the IME to suggest “phone” afterwards. Alternatively, a particle may be suggested after a number.

Another embodiment is directed to predicting default predictions when the IME cannot come up with anything to suggest. In this embodiment, a user may type something not in a stored table or dictionary used by the IME to find predictive text. Instead of suggesting nothing, the IME suggests commonly used phrases, characters, numbers, symbols, or other text that typically begin a sentence, such as “of,” “is,” or “in.”

Embodiments mentioned herein may take the form of a computer-program product that includes computer-useable instructions embodied on one or more computer-readable media. Computer-readable media include both volatile and nonvolatile media, removable and nonremovable media, and contemplates media readable by a database. The various computing devices, application servers, and database servers described herein each may contain different types of computer-readable media to store instructions and data. Additionally, these devices may also be configured with various applications and operating systems.

By way of example and not limitation, computer-readable media comprise computer-storage media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read-only memory (ROM), electrically erasable programmable read-only memory (EEPROM), flash memory used independently from or in conjunction with different storage media, such as, for example, compact-disc read-only memory (CD-ROM), digital versatile discs (DVD), holographic media or other optical disc storage, magnetic cassettes, magnetic tape, magnetic disk storage, or other magnetic storage devices. These memory devices can store data momentarily, temporarily, or permanently.

As used herein, “components” refer to a computer-related entity that may include hardware, software, and/or firmware. Components may, in some embodiments, operate in a client-server relationship to carry out various techniques described herein. Such computing is commonly referred to as “in-the-cloud” computing. For example, a component may be a process running on a processor, a library, a subroutine, and/or a computer or a combination of software and hardware. By way of illustration, both an application running on a server and the server may be a component. One or more components can reside within a process, and a component can be localized on a computing device (such as a server) or distributed between two or more computing devices communicating across a network.

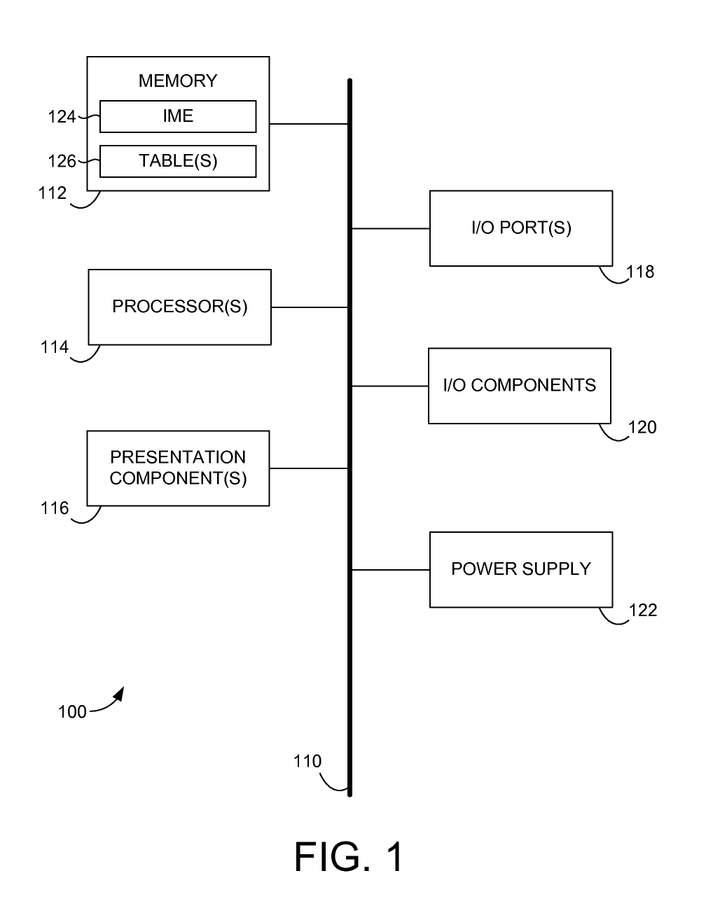

Referring initially to FIG. 1 in particular, an exemplary operating environment for implementing one embodiment is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of illustrated component parts. In one embodiment, computing device 100 is a personal computer. But in other embodiments, computing device 100 may be a mobile phone, handheld device, computing tablet, personal digital assistant (PDA), or other device capable of executing computer instructions.

Computing device 100 may be configured to run an operating system (“OS”) or mobile operating system. Examples of OSs include, without limitation, Windows® or Windows® Mobile, developed by the Microsoft Corporation®; Mac OS®, developed by Apple, Incorporated; Android®, developed by Google, Incorporated®; LINUX; UNIX; or the like. In one embodiment, the OS runs an IME 124 stored in memory 112. IME 124 is an input method editor like MS New Piynin, Smart Common Input Method (“SCIM”), or the like that uses different IM techniques (e.g., pinyin, Cangjie, Bopomofo, or the like) for predicting and suggesting text or characters on the computing device 100. Predicted characters and text may be presented on presentation component(s) 116 to the user, such as on a computer or mobile phone display. Particular to mobile phones and computing tablets, the predicted characters may be presented in a hot menu (i.e., listed above certain keys on a physical keyboard), in an on-screen touch-sensitive menu (commonly referred to as a “soft” keyboard or button), audibly, of some combination thereof.

To make certain predictions, IME 124 may access a table 126 of different entries stored in memory 112, or alternatively stored on a remote device accessible via a network connection. Table 126 may include various mappings of characters or text to different user entries. For example, a table like the following, which maps punctuation to common phrases like the, of, and it, for starting new sentences may be entered:

| | |
|---|---|
| . | [symbol] |
| ? | [symbol] |
| ! | [symbol] |

The above table provides a simple illustration of table 126; although, embodiments may obviously incorporate tables with myriad other mappings. Using the above table, when IME 124 detects a period (.), IME 124 consults the above table and determines that [symbol] , [symbol] , and [symbol] should be suggested to a user.

Table 126 may contain various mappings other than punctuation, such as predictions based on previously entered words or group of words. For example, “he told” may be mapped to “me,” “them,” “her,” or some other object that commonly fits afterwards. Or, in Chinese, [symbol] (“not more than”) may be mapped to [symbol] (“that”). Numerous other examples abound and need not be discussed at length herein, but what should be clear is that embodiments may include tables that map different words or phrases to predictive words or phrases.

Table 126 is not limited to characters and words, however. Phonetics may also be stored and mapped to predictive words or other phonetics. For example, [symbol] (“Ni”) may be mapped to [symbol] (“hao”), because it is likely that the user may be trying to spell out [symbol] (“hello”). Mappings of phonetics are not limited to 1-1 mappings, as various combinations of phonetics may be mapped to different predictions. Also, instead of merely mapping phonetics together, some embodiments predict characters based on entry of phonetics. So, in that regard, [symbol] (“ni”) may be mapped directly to [symbol] (“hello”). Numerous other examples abound and need not be discussed at length herein, but what should be clear is that embodiments may include tables that map different phonetics, or combinations of phonetics, to predictive characters, words, or phrases.

Table 126 may also map particles to predictive characters, punctuation, phonetics, words, or phrases. In other embodiments, table 126 maps parts of speech and/or input scopes of text areas to characters, words, phrases, and/or phonetics. An “input scope,” as referred to herein, is a tag associated with a text box. For example, Windows® Mobile tags text boxes with different input scope tags designating the context of text entered into the text box, such as: default, number, text, chat, URL, names, addresses, short message service (“SMS”) messages, multimedia messaging service (“MMS”) messages, or the like.

Embodiments described herein may be practiced in a variety of system configurations, including handheld devices, consumer electronics, general-purpose computers, specialty computing devices (e.g., tablets), etc. Embodiments described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation devices 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various hardware is not so clear, and metaphorically, the lines would more accurately be grey and fuzzy. For example, one may consider a presentation device, such as a monitor, to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “mobile phone,” etc., as all are contemplated within the scope of FIG. 1 and reference to “computing device.”

Computing device 100 may include a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices.

Memory 112 includes computer-storage media in the form of volatile and/or nonvolatile memory. The memory may be removable, nonremovable, or a combination thereof. Exemplary hardware devices include solid-state memory, hard drives, cache, optical-disc drives, etc. Computing device 100 includes one or more processors that read data from various entities such as memory 112 or I/O components 120. Presentation device 116 presents data indications to a user or other device. Exemplary presentation components include a display device, speaker, printing component, vibrating component, etc.

Specifically, memory 112 may be embodied with instructions for a web browser application, such as Microsoft Internet Explorer®. One skilled in the art will understand the functionality of web browsers; therefore, web browsers need not be discussed at length herein. It should be noted, however, that the web browser embodied on memory 112 may be configured with various plug-ins (e.g., Microsoft SilverLight™ or Adobe Flash). Such plug-ins enable web browsers to execute various scripts or mark-up language in communicated web content.

I/O ports 118 allow computing device 100 to be logically coupled to other devices including I/O components 120, some of which may be built in. Illustrative components include a microphone, joystick, game pad, satellite dish, scanner, printer, wireless device, etc.

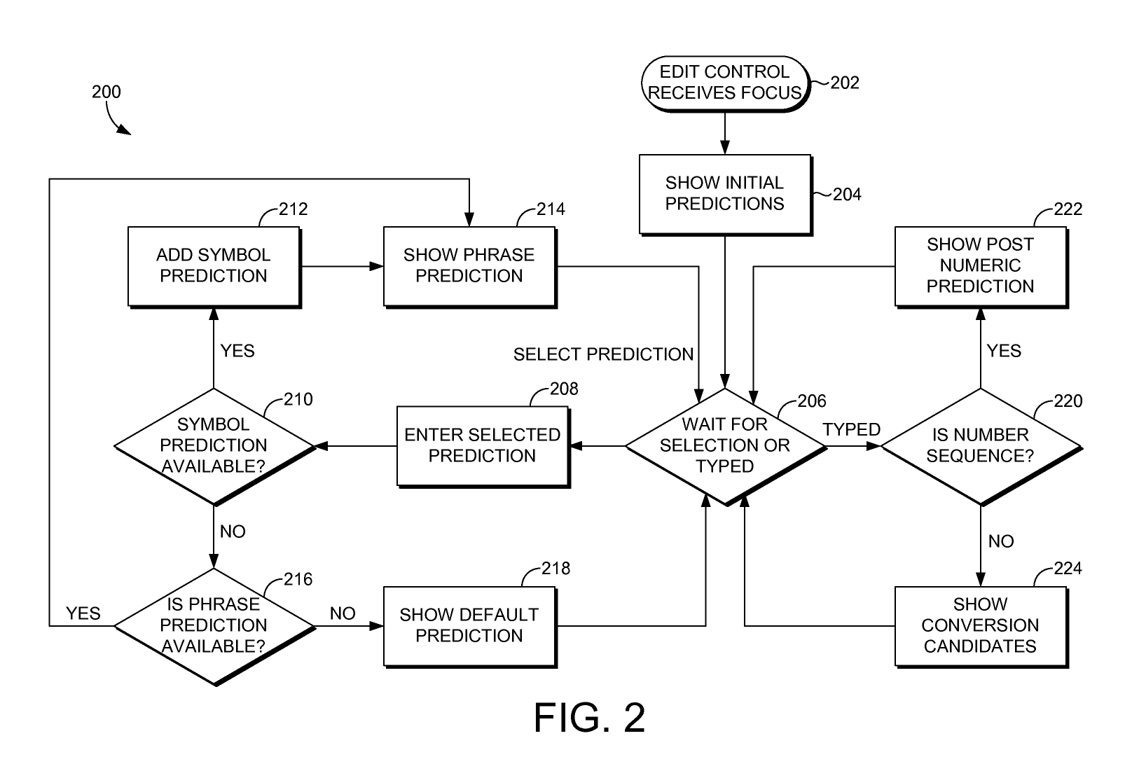

FIG. 2 is a diagram illustrating a flowchart of an IME, according to one embodiment. Flow 200 depicts several techniques for predicting characters, text, phrases, and/or punctuation to a user who can opt to insert the predictions through quick selection of a button (e.g., hot key, soft keyboard, hitting “Enter,” or the like). The seemingly sequential nature of flow 200 is not meant to require any particular sequence. Instead, flow 200 merely provides a glimpse into different capabilities of an IME configured according to different embodiments discussed herein.

As shown at 202, an edit control initially receives focus on a computing device. Examples of such focus include a user selecting a particular application, clicking on a text box, using a trackball to move a focus indicator to a particular text box, or the like. If the text box is empty, initial predictions are shown to the user, as shown at 204. In one embodiment, the initial predictions are pulled from a table of the most commonly used predictions. Commonality of the predictions may be determined merely by entry in the table (e.g., top five), based on statistics of use (e.g., user or users typically begin with “Hello,” “ [symbol] ,” or “Of”), or a combination thereof. The initial predictions may also take into account geographic regions, dialects, or historical user entries. Moreover, initial predictions may also be based on the input focus of the edit control, resulting in the predicted words entered into default text boxes and predicted numbers entered into number text boxes.

Decision block 206 indicates the user is free to select an initial prediction or disregard the initial prediction, opting instead to begin entering text. If the user selects a prediction, the prediction may be entered on the screen, shown at 208. Also, the IME checks to see if any symbols can be predicted, as shown at 210, by checking whether the edit control's input scope allows symbols and/or checking a table for symbols predicted after entry of the selection prediction. If symbols are allowed, predictive symbols found in a table may be shown to the user, as shown at 212. If symbols are not allowed, however, the input scope and/or table of predictions are checked to see if any phrases, characters, or text can be predicted based on the selected prediction as shown at 216. If not, a default prediction may be displayed to the user, as shown at 218. Yet, if predictions can be made, predicted phrases will be shown to the user, as shown at 214.

Looking again at decision block 206, if a user disregards the initial prediction and begins typing text, a determination is made at 220 whether a number sequence is being entered. A number sequence refers to a particular structure of numbers. Examples include ten digits for phone numbers, eight digits for social security numbers, two digits for minutes, or other types that indicate the context of a number (e.g., birthday, driver's license, etc.). If the IME detects that a number sequence is being entered, the IME, in one embodiment, shows post-numeric predictions, meaning predictions that typically follow such number types, as shown at 222. For example, a two digit number may invoke the IME to suggest that “minutes” should follow.

On the other hand, when the user enters phonetics to spell out characters or text, predictive conversion candidates are displayed, as shown at 224. Conversion candidates refer to characters that are relevant to particular phonetics (e.g., pinyin, Bopomofo, etc.) being entered. In one embodiment, conversion candidates are pulled from a table or dictionary. In other embodiment, conversion candidates are ranked according to the likelihood that the user is trying to spell each candidate, with the more likely candidates listed before less likely candidate. The likelihood may be based on a table entry, history or user selection, history of other users' selections, geographic region, or a combination thereof.

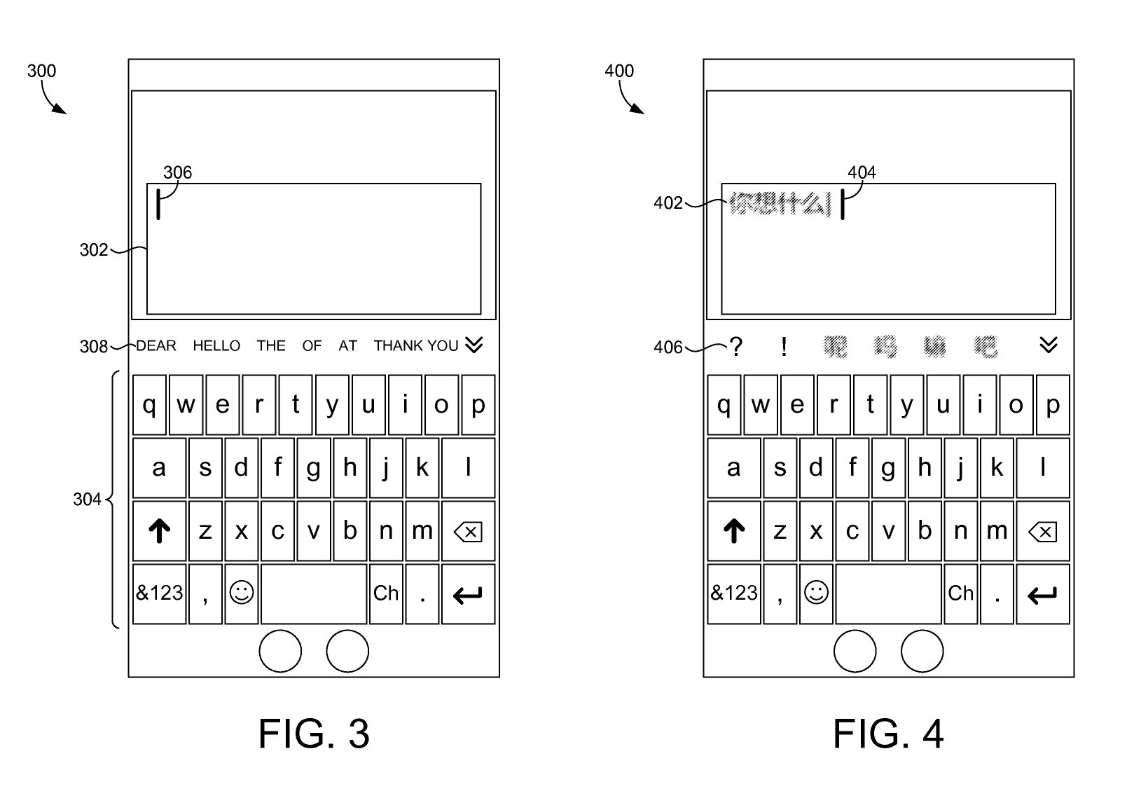

FIGS. 3-6 are diagrams of computing devices displaying predictions made by IMEs, according to different embodiments. In particular, FIG. 3 illustrates a computing device 300 (i.e., a smartphone) with a display 302 and keyboard 306. A cursor 306 showing focus in a text box prompts an IME to make predictions 308 and display predictions 308 to the user for selection. Because no text has been entered by the user yet, predictions 308 are initial predictions of text commonly entered when no text has been entered. As shown, salutations like “Dear,” “Hello,” and “Thank you,” are shown as well as common beginnings of sentences like “The,” “Of,” or “At.” Initial predictions may include phrases, or in some embodiments entire sentences, as well as symbols, numbers, or the combination thereof.

FIG. 4 illustrates a computing device 400 displaying a text box 402 in which a user has entered text up to a cursor 404. Predictions 406 are made and suggested based on the text entered by the user. As mentioned above, predictions may be based on tables, dictionaries, user interactions, geography, or the like, and may also include punctuation, symbols, or phrases.

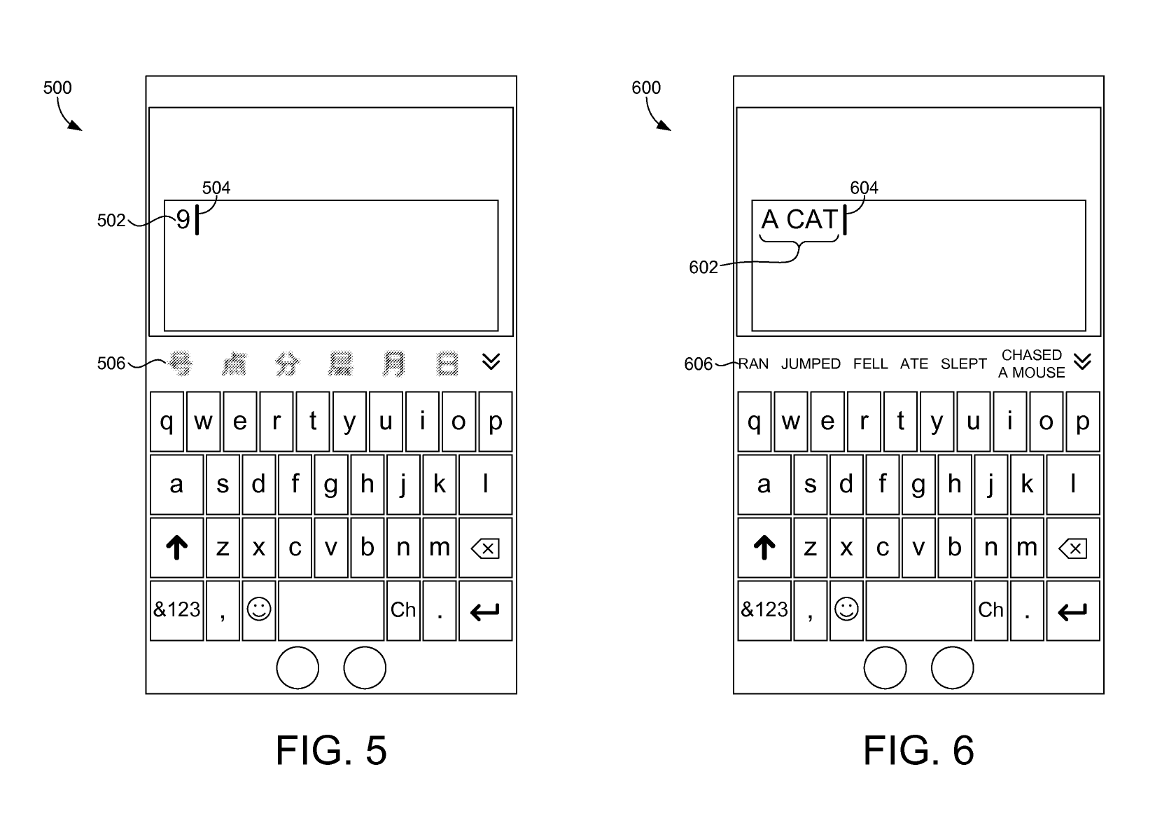

FIG. 5 illustrates a computing device 500 displaying a number 502 entered by a user up to a cursor 504. Based on the number and/or determined type of number (e.g., one digit, two digits, date of birth, password, social security number, etc.), an IME predicts and suggests several predictions 506 that the user can select. Similarly, FIG. 6 illustrates a computing device 600 displaying words 602 entered by a user up to a cursor 604. Based on words 602, an IME predicts and suggests several predictions 606 that the user can select.

The illustrated steps are not limited to a sequential manner, as some embodiments will perform the steps in parallel or out of the sequence illustrated. Furthermore, although the subject matter has been described in language specific to structural features and methodological acts, it is to be understood that the subject matter defined in the appended claims is not necessarily limited to the specific features or acts described above. Rather, the specific features and acts described above are disclosed as example forms of implementing the claims. For example, sampling rates and sampling periods other than those described herein may also be captured by the breadth of the claims.

The invention claimed is:

1. A computing device, comprising:
one or more processors configured to execute an input method editor configured to predict characters for entry in a text field (114 and 124);
a memory device configured to store executable instructions associated with the input method editor (124);
a display device configured to present a group of the characters predicted by the input method editor for selection by the user (116); and
an input device for receiving a selection of one of the group of the characters (120).

2. The one or more media of claim 1, wherein the computing device is a mobile phone.

3. The one or more media of claim 1, wherein the text field is associated with a text editor.

4. The one or more media of claim 3, wherein the text editor comprises a messaging application.

5. The one or more media of claim 1, wherein the input method editor predicts the group of the characters based on a determine context associated with the text field, wherein the determined context is identified from an input scope tag associated with the text field.

6. The one or more media of claim 5, wherein the input scope tag indicates at least one member of a group comprising MMS, SMS, password, name, address, and geographic location.

7. The one or more media of claim 1, wherein the input method editor predicts the characters before text is entered into the text field.

8. The one or more media of claim 1, wherein the input method editor predicts text based on the entry of a particle in the text field.

9. A method for predicting a text entry and presenting the characters on a display, comprising:
analyzing an entry in a text field in focus on a computing device (206);
accessing a table, stored in the memory on the computing, mapping a plurality of entries to symbols (224);
identifying the entry in the table (224); and
presenting, on the display, a group of the symbols mapped in the table to the entry (224).

10. The method of claim 9, further comprising:
receiving a selection of one of the group of symbols from a user; and
based on the selection, displaying the one of the group of symbols in the text field.

11. The method of claim 9, wherein the entry includes at least one member of a group comprising one or more letters, one or more phonetics, one or more words, one or more characters, a particle, and an indication of punctuation.

12. One or more computer-readable media, on a computing device, storing computer-executable instructions of a method for predicting a text entry in a text field and presenting the characters on a display, the method comprising:
analyzing one or more text entries previously entered by a user in a text field in focus on a computing device (210, 216, and 220);
accessing a table, stored in the memory on the computing, mapping a plurality of text entries to predictive text entries (210, 216, and 220);
based on the one or more text entries, identifying a group of the predictive text entries in the table (210, 216, and 220);
presenting the group of the predictive text entries on the display for a user to select (214, 218, and 224)).

13. The media of claim 12, wherein the one or more text entries comprise a word or a character.

14. The media of claim 12, wherein the one or more text entries comprise two or more words or characters.

15. The media of claim 12, wherein the predictive text entries are presented on the display in an order based on historical selection by users of the predictive text entries following the one or more text entries.

16. The media of claim 12, wherein the one or more text entries comprise one or more numbers.

17. The media of claim 16, further comprising:
determining the one or more numbers correspond to a particular number format, wherein identifying the group of the predictive text entries is based on the particular number format.

18. The media of claim 17, wherein the particular number format corresponds to at least one member of a group comprising an address, date of birth, social security number, telephone number, indication of time, and indication of geography.

19. The media of claim 12, further comprising:
determining no predictive entries correspond to the one or more text entries, and because so, presenting a group of default text entries on the display for user selection.

20. The one or more media of claim 19, wherein the default text entries comprise at least one entry that was selected based on a part of speech associated with the one or more text entries.
